(19) United States
(12) Patent Application Publication
(10) Pub. No.: US 2025/0179709 A1
(43) Pub. Date: Jun. 5, 2025

(54) CLOTHES CARE APPARATUS

(71) Applicant: Samsung Electronics Co., Ltd., Suwon-si (KR)

(72) Inventors: Hochae LEE, Suwon-si (KR); Sojeong KIM, Suwon-si (KR)

(21) Appl. No.: 18/933,309

(22) Filed: Oct. 31, 2024

Related U.S. Application Data
(63) Continuation of application No. PCT/KR2024/096388, filed on Oct. 24, 2024.

(30) Foreign Application Priority Data
Dec. 1, 2023 (KR) 10-2023-0172802

(51) Int. Cl. D06F 17/12; B08B 1/12

(52) U.S. Cl. CPC D06F 17/12; B08B 1/12

(57) ABSTRACT

A clothes care apparatus is provided. The clothes care apparatus includes a main body forming a clothes management room for accommodating a clothes therein and configured to spray plasma moisture air and detergent into the clothes management room, a sensor configured to detect a position of a polluted area of the clothes, a cleaning device including a friction portion configured to apply a physical force to the polluted area, and a moving device configured to move the friction portion to the position of the polluted area to allow the friction portion to contact the polluted area to press and rub against the polluted area.

### CROSS-REFERENCE TO RELATED APPLICATION(S)

This application is a continuation application, claiming priority under § 365(c), of an International application No. PCT/KR2024/096388, filed on Oct. 24, 2024, which is based on and claims the benefit of a Korean patent application number 10-2023-0172802, filed on Dec. 1, 2023, in the Korean Intellectual Property Office, the disclosure of which is incorporated by reference herein in its entirety.

### TECHNICAL FIELD

The disclosure relates to a clothes care apparatus. More particularly, the disclosure relates to a clothes care apparatus configured for managing clothes by applying a physical force to the clothes.

### BACKGROUND ART

In general, a clothes care apparatus is a device that performs clothes care, such as drying wet clothes, removing dirt attached to clothes or odors absorbed by clothes, and reducing wrinkles in clothes.

A clothes care apparatus typically includes a clothes management room, which is a storage space for clothes, and an electrical room, which includes a steam generator or a hot air supplier to perform refreshing functions, such as wrinkle removal, deodorization, static electricity removal, and the like. The clothes management room and the electrical room may be separated by a partition.

The clothes care apparatus may further include a cleaning process for removing contaminants from the clothes placed in the clothes management room. In this case, the cleaning process may include a process of spraying plasma moisture air, detergent and the like onto the clothes placed in the clothes management room.

In the case of spraying plasma moisture air onto the clothes, the plasma moisture air is sprayed onto the clothes at a low velocity, so methods to improve the physical force acting on the clothes are being actively researched.

The above information is presented as background information only to assist with an understanding of the disclosure. No determination has been made, and no assertion is made, as to whether any of the above might be applicable as prior art with regard to the disclosure.

### DISCLOSURE

### Technical Problem

Aspects of the disclosure are to address at least the above-mentioned problems and/or disadvantages and to provide at least the advantages described below. Accordingly, an aspect of the disclosure is to provide a clothes care apparatus including a structure capable of increasing the effectiveness of clothes care.

An aspect of the disclosure is to provide a clothes care apparatus that applies a physical force to a clothes to more effectively clean a polluted area of the clothes.

An aspect of the disclosure is to provide a clothes care apparatus including a structure capable of preventing secondary contamination of the clothes by polluted object generated during the cleaning of the clothes.

An aspect of the disclosure is to provide a clothes care apparatus that includes a structure capable of adjusting a physical force applied to a clothes based on a material of the clothes, thereby minimizing damage to the clothes.

Additional aspects will be set forth in part in the description which follows and, in part, will be apparent from the description, or may be learned by practice of the presented embodiments.

### Technical Solution

In accordance with an aspect of the disclosure, a clothes care apparatus is provided. The clothes care apparatus may include a main body forming a clothes management room for accommodating a clothes therein and configured to spray plasma moisture air and detergent into the clothes management room, a sensor configured to detect a position of a polluted area of the clothes, a cleaning device including a friction portion configured to apply a physical force to the polluted area, and a moving device configured to move the friction portion to the position of the polluted area to allow the friction portion to contact the polluted area to press and rub against the polluted area.

In accordance with another aspect of the disclosure, a clothes care apparatus is provided. The clothes care apparatus may include a main body forming a clothes management room that accommodates a clothes therein, wherein an inner surface of the main body forms a support wall supporting the clothes and the main body is configured to spray plasma moisture air and detergent into the clothes management room, a sensor configured to detect a position of a polluted area of the clothes, a cleaning device configured to press and rub against the polluted area, a moving device configured to move the cleaning device to allow the cleaning device to contact the polluted area. The moving device may include a first moving device arranged to extend in a first direction within the clothes management room. The moving device may include a second moving device extending in a second direction intersecting the first direction and connected to the first moving device to be movable in a direction parallel to the first direction. The moving device may include a third moving device connected to the second moving device so as to be movable in the direction parallel to the second direction, and configured to extend from another surface of the main body facing the inner surface in the third direction facing the support wall. The cleaning device may be disposed at an end of the third moving device facing the support wall.

In accordance with another aspect of the disclosure, a clothes care apparatus is provided. The clothes care apparatus may include a main body forming a clothes management room accommodating a clothes therein, and configured to spray plasma moisture air and detergent into the clothes management room, a sensor configured to detect a position of a polluted area of the clothes, a cleaning device configured to apply a physical force to the polluted area, a moving device connected to the cleaning device and configured to move the cleaning device. The movement of the cleaning device by the moving device may include moving to the position of the polluted area so as to contact the polluted area. The movement of the cleaning device may include moving to a support wall, which is an inner surface of the main body formed on the opposite side of the cleaning device with respect to the clothes, so as to press the polluted area against the support wall, and moving in the direction in which the support wall extends to rub against the pressed polluted area.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a perspective view illustrating a clothes care apparatus according to an embodiment of the disclosure;

FIG. 2 is a view illustrating an open door of a clothes care apparatus according to an embodiment of the disclosure;

FIG. 3 is a cross-sectional view of a clothes care apparatus according to an embodiment of the disclosure;

FIG. 4 is a partial view illustrating a cleaning device and a moving device in a clothes care apparatus according to an embodiment of the disclosure;

FIG. 5 is a control block diagram of a clothes care apparatus according to an embodiment of the disclosure;

FIG. 6 is a view illustrating a clothes care apparatus, wherein a friction portion of a cleaning device is moved to contact a polluted area of the clothes, according to an embodiment of the disclosure;

FIG. 7 is a flowchart illustrating a method of controlling a clothes care apparatus, wherein a friction portion is moved to contact a polluted area, according to an embodiment of the disclosure;

FIG. 8 is a view illustrating a clothes care apparatus, wherein a friction portion of a cleaning device is moved to press and rub against a polluted area and a suction draws in a polluted object, according to an embodiment of the disclosure;

FIG. 9 is a flowchart illustrating a method of controlling a clothes care apparatus, wherein a friction portion presses and rubs against a polluted area and a suction draws in a polluted object, according to an embodiment of the disclosure;

FIG. 10 is a view illustrating a clothes care apparatus, wherein a spray portion and an ultrasonic generator of a cleaning device are operated, according to an embodiment of the disclosure;

FIG. 11 is a flowchart illustrating a method of controlling a clothes care apparatus to operate a spray portion according to an embodiment of the disclosure;

FIG. 12 is a flowchart illustrating a method of controlling a clothes care apparatus to operate a ultrasonic generator according to an embodiment of the disclosure;

FIG. 13 is a view illustrating a clothes care apparatus, wherein a friction body and a friction member of a spray portion are separated from each other, according to an embodiment of the disclosure;

FIG. 14 is a flowchart illustrating a method of controlling a clothes care machine according to an embodiment of the disclosure;

FIG. 15 is a flowchart illustrating a method of controlling a clothes care apparatus according to an embodiment of the disclosure;

FIG. 16 is a flowchart illustrating a method of controlling a clothes care apparatus according to an embodiment of the disclosure; and

FIG. 17 is a view illustrating a state in which a door of a clothes care apparatus is open according to an embodiment of the disclosure.

Throughout the drawings, it should be noted that like reference numbers are used to depict the same or similar elements, features, and structures.

### MODES OF THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, the same reference numerals or signs shown in the drawings of the disclosure indicate elements or components performing substantially the same function.

In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, or the like, may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

As used herein, the terms “front”, “rear”, “upper”, “lower”, “left”, “right”, “up”, “down”, and the like are defined with reference to the drawings and are not intended to limit the shape and location of each component.

When an element (e.g., a first element) is referred to as being “(functionally or communicatively) coupled,” or “connected” to another element (e.g., a second element), the first element may be connected to the second element, directly (e.g., wired), wirelessly, or through a third element.

Throughout the description, when an element is “on” another element, this includes not only when the element is in contact with the other element, but also when there is another element between the two elements.

In referring to the direction of rotation, the clockwise direction may be represented as a first direction and the counterclockwise direction, which is the opposite of the first direction, as a second direction. Such expressions may be used in describing specific details for implementing the disclosure, but the direction of rotation of the configurations of the disclosure is not limited by these terms.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

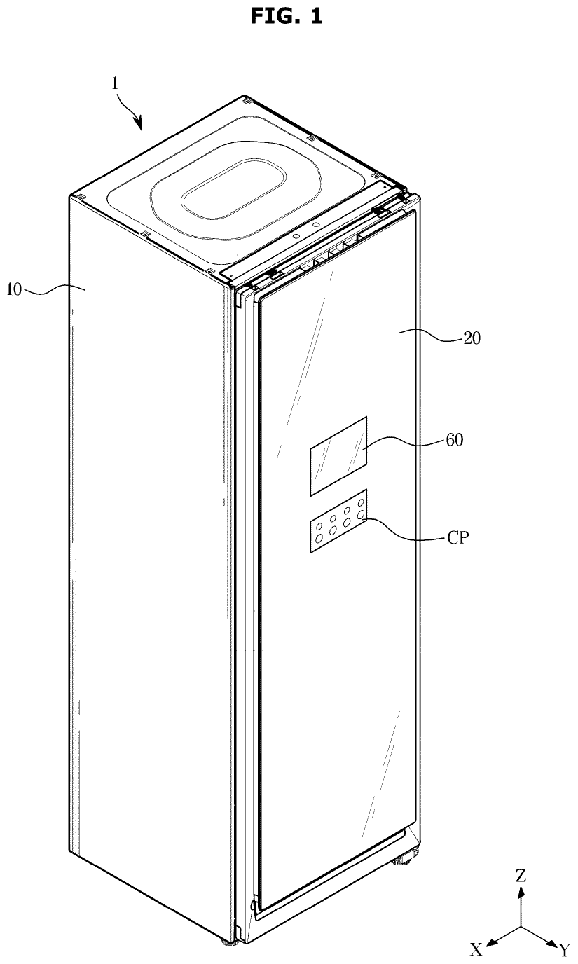

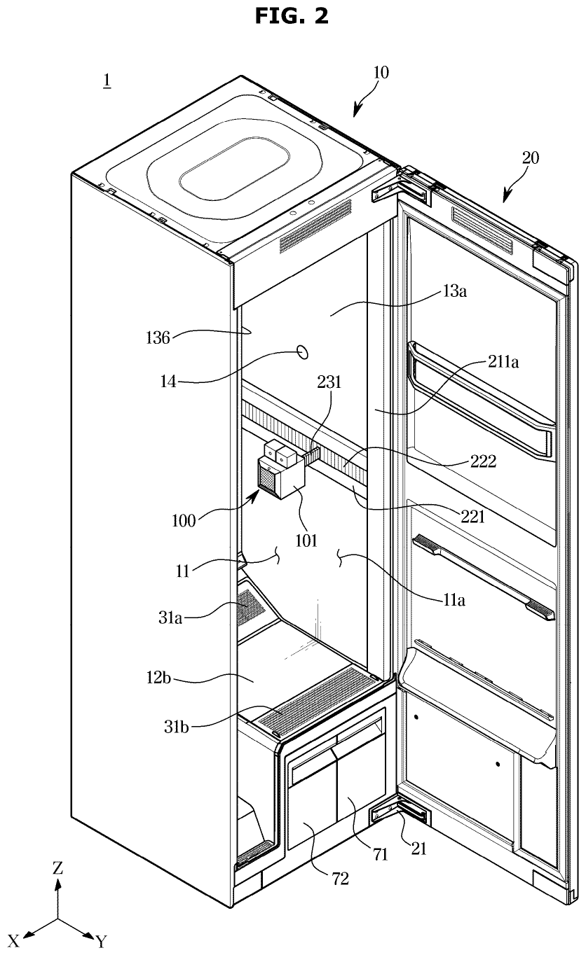

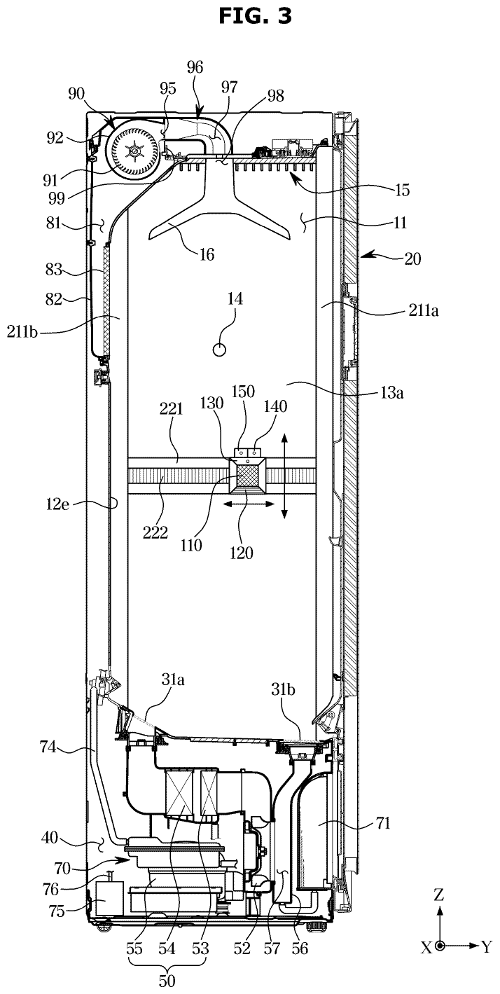

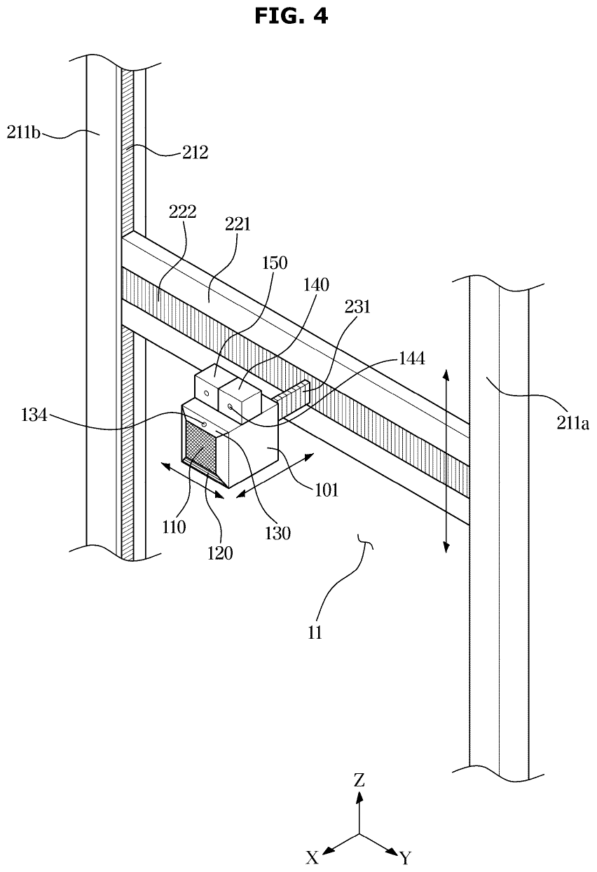

FIG. 1 is a perspective view illustrating a clothes care apparatus according to an embodiment of the disclosure. FIG. 2 is a view illustrating an open door of a clothes care apparatus according to an embodiment of the disclosure. FIG. 3 is a cross-sectional view of a clothes care apparatus according to an embodiment of the disclosure. FIG. 4 is a partial view illustrating a cleaning device and a moving device in a clothes care apparatus according to an embodiment of the disclosure.

Referring to FIGS. 1 to 4, a clothes care apparatus 1 may include a main body 10 forming an exterior and a door 20 rotatably coupled to the main body 10.

The clothes care apparatus 1 may include a clothes management room 11 provided inside the main body 10 to receive and manage a clothes C, and a hanger 16 provided inside the clothes management room 11 to hold the clothes C.

The main body 10 may have an approximately hexahedral shape with the clothes management room 11 formed therein and may be open on one side. An opening 11a may be formed in the front of the main body 10. The main body 10 may be provided with a door 20 rotatably coupled to the main body 10 to open or close the clothes management room 11. For example, the door 20 may be installed on the main body 10 via a hinge 21, a link, or the like.

For example, the clothes care apparatus 1 may include a display portion 60 that displays information on the process of managing the clothes C (e.g., garment, laundry, or the like) and the like, and a control panel CP provided to adjust the operation of the clothes care apparatus 1. For example, the display portion 60 and the control panel CP may be disposed on one side of the door 20 facing the outside, so that a user may easily identify the information on the process of managing the clothes C and adjust the operation of the clothes care apparatus 1.

In an embodiment of the disclosure, to display the information on the process of managing the clothes C to a user, the display portion 60 may include a cathode ray tube (CRT), a digital light processing (DLP) panel, and a plasma display panel (PDP), a liquid crystal display (LCD) panel, an electro luminescence (EL) panel, an electrophoretic Display (EPD) panel, an electrochromic display (ECD) panel, a light emitting diode (LED) panel, an organic light emitting diode (OLED) panel, or the like, but is not limited thereto.

Although the display portion 60 and the control panel CP are shown and described as separate in the drawings, but the display portion 60 and the control panel CP may be provided as a single device that performs both input and output. For example, the display portion 60 and the control panel CP may include a graphical user interface (GUI), that is, a software device, such as a touch pad. The touch pad may be implemented as a touch screen panel (TSP) to form a mutual layered structure with an output portion of the user interface device.

The clothes management room 11 may form a space in which the clothes C is accommodated. The clothes management room 11 may be formed as a space enclosed by an upper surface, a lower surface 12b, a left surface, a right surface, and a rear surface 12e provided inside the main body 10. As will be described later, the left surface may be a first side 13a, and the right surface may be a second side 13b or a support wall 136.

A front surface of the clothes management room 11 may be formed to be open, i.e., to have an opening. As a result, the opening of the clothes management room 11 may also be opened or closed by the door 20 that opens or closes the opening 11a of the main body.

The clothes care apparatus 1 may include a machine room 40 including a heat exchanger 50 provided to dehumidify or heat the air inside the clothes management room 11, a plasma generator 75 provided to change the air into a plasma state, and a steam generator 70 provided to provide moisture air. A state in which the air in plasma is mixed with moisture air may be defined as a plasma moisture air state.

The main body 10 may include the hanger 16 provided inside the clothes management room 11 to support the clothes C. The hanger 16 may be formed in the shape of a coat hanger for hanging the clothes C. However, the hanger 16 is not limited to a hanger shape.

In an embodiment of the disclosure, the hanger 16 may be configured to allow air to flow therein. The air supplied into the hanger 16 may remove dust and foreign substances from the clothes C. For example, an air hole may be formed in the hanger 16 to supply air to the clothes C. The air hole may be formed on an upper end of the hanger 16 and may be in communication with a second airflow outlet 98, which will be described later, to deliver the air discharged from the second airflow outlet 98 to the clothes C.

The clothes management room 11 may include a first airflow outlet 31a and the second airflow outlet 98, and a first airflow inlet 31b and a second airflow inlet 83.

In an embodiment of the disclosure, the first airflow outlet 31a and the first airflow inlet 31b may be formed on a lower surface of the clothes management room 11. The first airflow outlet 31a may be disposed on a rear side of the lower surface of the clothes management room 11. The first airflow inlet 31b may be disposed on a front side of the lower surface of the clothes management room 11. The first airflow outlet 31a and the first airflow inlet 31b may be disposed adjacent to each other.

In an embodiment of the disclosure, the second airflow outlet 98 may be formed on an upper surface of the clothes management room 11. The second airflow inlet 83 may be formed at the center of the rear surface 12e of the clothes management room 11. The second airflow outlet 98 and the second airflow inlet 83 may be disposed adjacent to each other.

The second airflow outlet 98 of the clothes management room 11 may be connected to the hanger 16. In other words, the second airflow outlet 98 may communicate with the air hole of the hanger 16. Accordingly, the air discharged through the second airflow outlet 98 may be delivered to the hanger 16 and then delivered to the clothes C placed on the hanger 16.

A drain tank 72 and a water supply tank 71 that are provided detachably from the main body 10 may be installed at a lower portion of the main body 10. The drain tank 72 and the water supply tank 71 may be disposed in the lower portion of the clothes management room 11.

The drain tank 72 may be configured to facilitate the treatment of condensed water by the heat exchanger 50. The water supply tank 71 may store water required to generate steam in the steam generator 70. Water from the water supply tank 71 may be supplied to the steam generator 70 and used to generate steam. The water supply tank 71 may be detachably installed from the main body 10 to facilitate water replenishment.

The drain tank 72 and the water supply tank 71 may be disposed on the front side of the machine room 40. The machine room 40 may be arranged on a lower side of the main body 10. The machine room 40 may be arranged in the lower portion of the clothes management room 11.

The steam generator 70 may be connected to the water supply tank 71 to receive water to form steam. The steam generator 70 may further include a steam supply pipe 74 that guides the generated steam to a management room sprayer 15. The steam guided to the management room sprayer 15 may be sprayed onto the clothes C received in the clothes management room 11.

The main body 10 may include the management room sprayer 15. For example, the management room sprayer 15 may be disposed on the upper side (+Z side) of the clothes management room 11. The management room sprayer 15 may include a plurality of spray nozzles. The plurality of spray nozzles may be arranged on the upper side of the clothes management room 11 to be spaced apart at regular intervals.

The management room sprayer 15 may be coupled to the upper surface of the clothes management room 11 to allow the plurality of spray nozzles to spray plasma moisture air from the upper surface of the clothes management room 11 toward the lower side (−Z side). The Plasma moisture air may be sprayed into the clothes management room 11 via the management room sprayer 15 to provide steam and plasma to the clothes C.

In the drawings, the steam generated by the steam generator 70 is shown as being injected into the clothes C from the upper side of the clothes management room 11 by the management room sprayer 15, but this is by way of an example only, and the management room sprayer 15 may be arranged such that steam flows into the clothes management room 11 through a side or bottom of the main body 10.

The plasma generator 75 may be provided to convert air to a plasma state. Air converted to a plasma state may be supplied to the clothes management room 11.

More particularly, the air converted to a plasma state may be guided to the management room sprayer 15 via a plasma supply pipe 76 included in the main body 10. As a result, the air and steam in the plasma state may be mixed with each other and sprayed into the clothes management room 11 in the plasma moisture air state via the management room sprayer 15.

The Plasma moisture air sprayed into the clothes management room 11 may be provided to act on the clothes C to clean the clothes C.

In an embodiment of the disclosure, the clothes care apparatus 1 may include a sensor 14 that detects the clothes C positioned in the clothes management room 11. More particularly, the sensor 14 may be configured to detect the position of a polluted area P of the clothes C.

The sensor 14 may be referred to by various alternative expressions representing the same/similar configuration in terms of detecting external information. For example, sensor may be replaced by expressions, such as detector, probe, sensing device, sensor portion, input unit, input device, and the like, and is not limited to the examples described above. For ease of description, the configuration that detects the position of the polluted area P of the clothes C will be referred to as the ‘sensor 14’ and will be described below.

As described above, the sensor 14 may include various types of devices that may detect information about the clothes C and information about the polluted area P. In an embodiment of the disclosure, the sensor 14 may include an optical device that collects information about the clothes C and the polluted area P using the amount of light reflected from incident light from a light source. In an embodiment of the disclosure, the sensor 14 may include an ultrasonic device that emits ultrasonic waves to collect information about the clothes C and the polluted area P. In an embodiment of the disclosure, the sensor 14 may include an electrical conductivity device that collects information about the clothes C and the polluted area P based on the material of the clothes C and the nature of a polluted object PO in the polluted area P having different electrical properties. For example, the sensor 14 may include an infrared sensor 14 that collects information about the clothes C and the polluted area P by emitting infrared rays to the clothes C and the polluted area P.

The types and names of the sensors 14 described above may be by way of example only, and it should be understood that the sensor 14 may be provided in a various devices that perform the function of collecting information about the clothes C and the polluted area P.

In an embodiment of the disclosure, the sensor 14 may be disposed on one surface forming the clothes management room 11. The sensor 14 may be attached to the first side 13a so as to face an inside of the clothes management room 11, but this is by way of example only and the position at which the sensor 14 is disposed may be varied depending on the position at which it is capable of detecting information about the clothes C received in the clothes management room 11.

In an embodiment of the disclosure, the sensor 14 may include a plurality of sensors 14. The plurality of sensors 14 may be arranged to detect information about the clothes C and information about the polluted area P.

The clothes care apparatus 1 may include a cleaning device 100 provided to clean the polluted area P of the clothes C and a moving device 200 provided to move the cleaning device 100. As will be described later, the cleaning device 100 may be configured to spray detergent and plasma moisture air onto the polluted area P, apply a frictional force, and draw in the polluted object PO, thereby removing the polluted object PO from the polluted area P.

In light of the described above, the cleaning device 100 may be replaced by various alternative expressions, such as washing assembly, washing device, cleaner, cleaning assembly, decontamination remover, decontamination device, washing unit, washing device, washing assembly, and the like in the context of removing polluted object from the polluted area P, and is not limited to the examples described above. For ease of description, the configuration for removing the polluted object PO from the polluted area P of the clothes C will be referred to as the ‘cleaning device 100’ and will be described below.

The moving device 200 may be replaced by various alternative expressions representing the same/similar configuration in terms of moving the cleaning device 100 and changing the position of the cleaning device 100. For example, the moving device 200 may be replaced by expressions, such as movement device, transporting device, conveying device, carrying device, transport unit, conveying unit, mobile robot, guiding device, or the like, and is not limited to the examples described above. For ease of description, the foregoing configuration for moving the cleaning device 100 will be referred to as the ‘moving device 200’ and will be described below.

As will be described below, the moving device 200 may be configured to move a friction portion 110 of the cleaning device 100 to the position of the polluted area P to allow the friction portion 110 of the cleaning device 100 to contact the polluted area P of the clothes C to press and rub against the polluted area P.

The cleaning device 100 may be arranged to be movable by the moving device 200 to apply a physical force or the like to the polluted area P of the clothes C. In an embodiment of the disclosure, the cleaning device 100 may be coupled to the moving device 200 and may be movable by driving the moving device 200.

The cleaning device 100 may include a cleaning body 101 forming an exterior thereof, a friction portion 110 disposed facing the first side 13a of the clothes management room 11 to apply a physical force to the polluted area P of the clothes C, and a suction portion 120 provided to draw in the polluted object PO.

As will be described later, the friction portion 110 may be provided to apply a frictional force to the polluted area P of the clothes C. In terms of the friction portion 110 applying a frictional force to the polluted area P of the clothes C, the friction portion 110 may be replaced by various alternative expressions representing the same/similar concept. For example, the friction portion 110 may be replaced by expressions, such as friction part, mechanical force application part, physical force application portion, rubber, rubber portion, or the like, and is not limited to the examples described above. For ease of description, the above configuration will be referred to as the ‘friction portion 110’ and will be described later.

The cleaning device 100 may include a spray portion 130 provided to spray detergent and plasma, an ultrasonic generator 140 capable of generating ultrasonic waves, and an auxiliary sensor 150 provided to identify whether the cleaning of the polluted area P is complete.

Although the cleaning body 101 is shown in the drawings as having an approximately rectangular shape, but this is by way of example only and the cleaning body 101 may have various shapes. Further description of the cleaning device 100 will be described later.

The moving device 200 may include a first moving device 211 (including 211a and 211b) arranged to extend in a first direction within the clothes management room 11. In an embodiment of the disclosure, the first direction in which the first moving device 211 extends may be a vertical direction (+−Z direction).

In an embodiment of the disclosure, the first moving device 211 may include a first moving rail 212 (see FIG. 4). In an embodiment of the disclosure, the first moving rail 212 may extend in the vertical direction and may be arranged to be movable in the vertical direction through a power source, such as a motor (not shown).

The first moving device 211 may include a pair of first moving devices 211 disposed at a front (+Y direction) and a rear (−Y direction) of the clothes management room 11, respectively. Each of the pair of first moving devices 211 may include the first moving rails 212 arranged to face each other. The cleaning device 100 coupled to the moving device 200 may be arranged to be movable in a direction parallel to the first direction by driving the first moving device 211.

The moving device 200 may include a second moving device 221 extending in a second direction intersecting the first direction within the clothes management room 11, and connected to the first moving device 211 and arranged to be movable in a direction parallel to the first direction along the first moving device 211. In an embodiment of the disclosure, the second direction in which the second moving device 221 extends may include a front-to-back direction (+−Y direction).

In an embodiment of the disclosure, one end and the other end of the second moving device 221 may be coupled to each of the pair of first moving devices 211. More particularly, opposite ends of the second moving device 221 may be coupled to first moving rails 212 provided on each pair of first moving devices 211. Accordingly, in response to the first moving rails 212 moving in the direction parallel to the first direction according to the driving of the first moving device 211, the second moving device 221 may move in the direction parallel to the first direction according to the driving of the first moving device 211.

In an embodiment of the disclosure, the second moving device 221 may include a second moving rail 222 extending in the second direction. In an embodiment of the disclosure, the second moving rail 222 may extend along the front-to-back direction (+−Y direction) and may be arranged to be movable in the front-to-back direction through a power source, such as a motor (not shown). The cleaning device 100 coupled to the moving device 200 may be arranged to be movable in a direction parallel to the second direction by driving the second moving device 221.

In an embodiment of the disclosure, the first moving device 211 and the second moving device 221 may be disposed on an inner surface of the main body 10 facing the second side 13b. In another expression, the first moving device 211 and the second moving device 221 may be arranged to be supported on the first side 13a.

The moving device 200 may include a third moving device 231 connected to the second moving device 221 and arranged to be movable in the direction parallel to the second direction along the second moving device 221, and arranged to extend in a third direction facing the second side 13b from an inner surface of the main body 10. The third moving device 231 may be arranged to extend in a direction parallel to the third direction. For example, the third direction may include a left-to-right direction (+−X direction).

In an embodiment of the disclosure, one end of the third moving device 231 facing the first side 13a may be connected to the second moving device 221. Accordingly, in response to the second moving rail 222 moving in the direction parallel to the second direction according to the driving of the second moving device 221, the third moving device 231 may move in the direction parallel to the second direction according to the driving of the second moving device 221.

In an embodiment of the disclosure, the third moving device 231 may extend such that, relative to one end facing the first side 13a the other end is movable toward the second side 13b. In addition, the third moving device 231 may be retracted to allow the other end, which has moved toward the second side 13b, to move back toward the first side 13a.

As a result, the cleaning device 100 coupled to the moving device 200 may be arranged to be movable in the direction parallel to the third direction by extending and retracting of the third moving device 231.

The configuration and operation method of the moving device 200 described above may be one of many examples for moving the cleaning device 100, and the configuration and operation of the cleaning device 100 may be provided in a variety of ways as long as the cleaning device 100 is to be movable within the clothes management room 11.

The heat exchanger 50 may be provided to dehumidify and heat the air inside the clothes management room 11 as needed. In an embodiment of the disclosure, the need to dehumidify and heat the air inside the clothes management room 11 may include, for example, drying the clothes C to which the sprayed plasma moisture air has been applied.

The heat exchanger 50 may be installed to supply hot air to the interior of the clothes management room 11. The heat exchanger 50 may include an evaporator 53, a condenser 54, and a compressor 55 through which a refrigerant circulates, and may be configured to dehumidify and heat air.

As the refrigerant evaporates in the evaporator 53 of the heat exchanger 50, it may absorb latent heat from the surrounding air, thereby condensing and removing moisture from the air. When the refrigerant is condensed in the condenser 54 via the compressor 55, latent heat may be released to the surrounding air, thereby heating the surrounding air. In other words, the evaporator 53 and the condenser 54 may perform a heat exchange function, so that the air entering the machine room 40 by a circulation fan 52 may be dehumidified and heated by sequentially passing through the evaporator 53 and the condenser 54.

In an embodiment of the disclosure, the heat exchanger 50 installed in the machine room 40 may include a first circulation duct 56 connecting the evaporator 53, the condenser 54, and the circulation fan 52. The first circulation duct 56 may be connected to the clothes management room 11 to form a first circulation flow path 57 that circulates between the clothes management room 11 and the first circulation duct 56.

The first circulation duct 56 may be connected to the first airflow inlet 31b and the first airflow outlet 31a of the clothes management room 11. The air in the clothes management room 11 may flow into the first circulation duct 56 through the first airflow inlet 31b, and the inflowing air may be dehumidified and then discharged back into the clothes management room 11 through the first airflow outlet 31a.

The interior of the clothes management room 11 may be provided with the hanger 16 to allow the clothes C to be hung. The hanger 16 may be installed on the upper surface of the clothes management room 11.

In an embodiment of the disclosure, the hanger 16 may be detachably installed in the clothes management room 11. The hanger 16 may be provided with at least one or more hangers.

The clothes management room 11 may include a blower 90 for flowing air within the clothes management room 11.

The clothes management room 11 may include a second circulation flow path 81 provided to circulate the air inside the clothes management room 11 by the blower 90.

The second circulation flow path 81 may be arranged to communicate with the clothes management room 11 and may form at least a portion of the second circulation flow path 81 that circulates the clothes management room 11 and the second circulation flow path 81. The blower 90 may be disposed in the second circulation flow path 81.

The blower 90 may be disposed on the upper rear side of the clothes management room 11 and may include a motor 93 generating a rotational force and at least one fan 91 rotated by the motor 93. The fan 91 may be accommodated in a fan housing 92.

The fan housing 92 may be coupled to a duct bracket 99 provided on an upper surface 12a of the clothes management room 11.

For example, the second circulation flow path 81 may be formed on a rear side of the second airflow inlet 83 of the clothes management room 11.

The air flowing into the second circulation flow path 81 may flow to a top cover disposed on the upper portion of the clothes management room 11 via the blower 90. In an embodiment of the disclosure, the blower 90 may be installed between the second circulation flow path 81 and the top cover.

The second circulation flow path 81 may be connected to the second airflow inlet 83 and the second airflow outlet 98 of the clothes management room 11. An inlet of the second circulation flow path 81 may be integrated with the second airflow inlet 83 of the clothes management room 11, such that the inlet of the second circulation flow path 81 and the second airflow inlet 83 are considered to have the same configuration.

One end of the second circulation flow path 81 may be formed by the second airflow inlet 83, and the other end of the second circulation flow path 81 may be formed by the second airflow outlet 98. The second circulation flow path 81 may be formed by a connection duct 96 connecting the second circulation flow path 81 to the blower 90 and the blower 90 to the second airflow outlet 98.

In other words, one end of a second circulation duct 82 may be formed by the second airflow inlet 83, and the other end of the second circulation flow path 81 may be arranged to provide air to the blower 90.

The blower 90 may include the connection duct 96. The connection duct 96 may include an outlet 95 through which air discharged from the fan 91 flows, and an inlet 97 provided to communicate with the clothes management room 11. The inlet 97 may communicate with the second airflow outlet 98 to allow air to be guided to the hanger 16.

The second airflow outlet 98 may communicate with the hanger 16 to allow a portion of the air introduced from the second circulation duct 82 to be delivered to the hanger 16. The air delivered through the hanger 16 may be sprayed onto the clothes C to blow away dust, foreign substances, and the like from the clothes C.

In an embodiment of the disclosure, the hanger 16 may be installed on the upper surface of the clothes management room 11. The hanger 16 may be installed detachably by a support device installed on the upper surface of the clothes management room 11.

In an embodiment of the disclosure, the hanger 16 is shown as an example in which air supplied through an upper air supply port, i.e., the second airflow outlet 98, may be supplied to the inside and outside of the clothes C. However, the disclosure is not limited thereto. For example, the air supply port may be formed at different positions and in different sizes to provide a wide range of air blowing onto the clothes C.

The blower 90, which is arranged to be connected to the second circulation duct 82, may be arranged to draw in the air inside the clothes management room 11 through the second airflow inlet 83 and discharge the drawn-in air through the second airflow outlet 98.

In the following, the process by which the clothes C stored in the clothes management room 11 is cared for will be briefly described.

The user may open the door 20 to accommodate the clothes C in the clothes management room 11. The clothes C accommodated in the clothes management room 11 may be supported by the hanger 16 and positioned inside the clothes management room 11.

In response to the user inputting a command to the clothes care apparatus 1 via the control panel CP, the display portion 60 may display information to the user regarding the process by which the clothes C are cared for, and the process of caring for the clothes C may proceed in accordance with the user's command.

The blower 90 may allow air to flow such that air is discharged to the second airflow outlet 98 through the second circulation duct 82. The air discharged through the second airflow outlet 98 may pass through the hanger 16 and flow to the clothes C. The air flowing to the clothes C may flow from the top to the bottom and may act as a primary source for blowing off dust and foreign substances stuck on the clothes C.

Steam generated in the steam generator 70 may flow to the management room sprayer 15 through the steam supply pipe 74. Air in a plasma state, which has been changed in the plasma generator 75, may flow to the management room sprayer 15 through the plasma supply pipe 76. The steam and plasma-state air may then be mixed together and sprayed into the clothes management room 11 through the management room sprayer 15 as plasma moisture air.

The plasma moisture air may be uniformly applied to the clothes C placed in the clothes management room 11. The plasma moisture air may perform the function of cleaning the polluted area P of the clothes C.

The moving device 200 may move the cleaning device 100. The moving device 200 may move the cleaning device 100 such that the friction portion 110 of the cleaning device 100 comes into contact with the polluted area P of the clothes C. Thereafter, the moving device 200 may move the cleaning device 100 to allow the friction portion 110 to press and rubs the polluted area P against the support wall 136 to apply a physical force to the polluted area P.

The spray portion 130 and the ultrasonic generator 140 may be arranged to provide detergent and additional physical force necessary to clean the polluted area P. Then, based on the polluted object PO flowing out from the polluted area P, the suction portion 120 may draw in the polluted object PO to prevent secondary contamination of the clothes C. Then, upon identifying whether the cleaning of the polluted area P is completed by the auxiliary sensor 150, the cleaning operation by the cleaning device 100 may be terminated. In an embodiment of the disclosure, during the cleaning operation by the cleaning device 100, plasma moisture air may be additionally sprayed from the management room sprayer 15 as needed. A further description of the specific configuration and operation method of the cleaning device 100 described above will be described later.

In response to the completion of the cleaning operation of the cleaning device 100, the air dehumidified and heated by the heat exchanger 50 may be discharged to the clothes management room 11 through the first airflow outlet 31a. The dehumidified and heated air discharged to the clothes management room 11 may dry the wet clothes C by using plasma moisture air and supply heat to the clothes C to perform functions, such as sterilization and wrinkle removal. In addition, the function of drying the clothes management room 11 may be performed. Then, the display portion 60 may display a message that the management of the clothes C is completed.

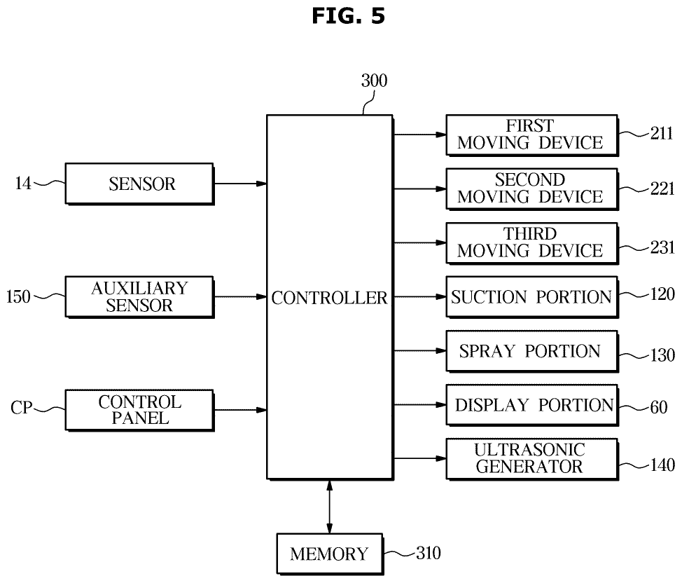

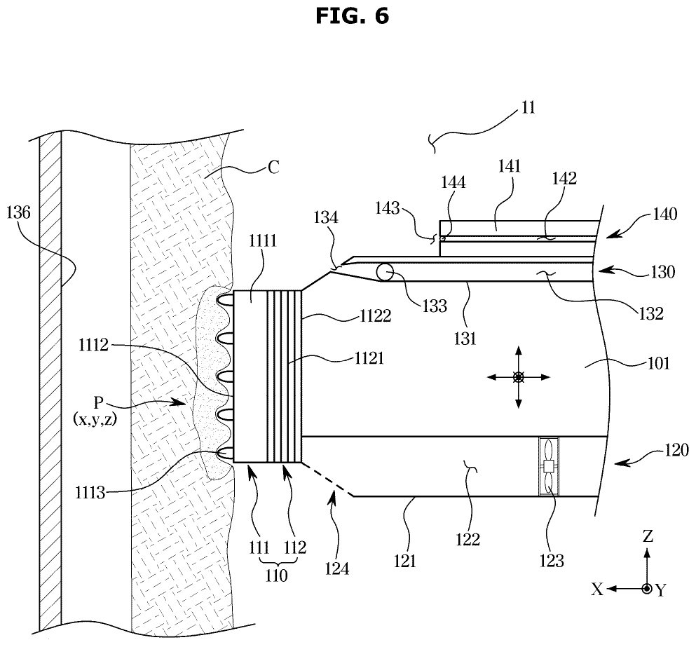

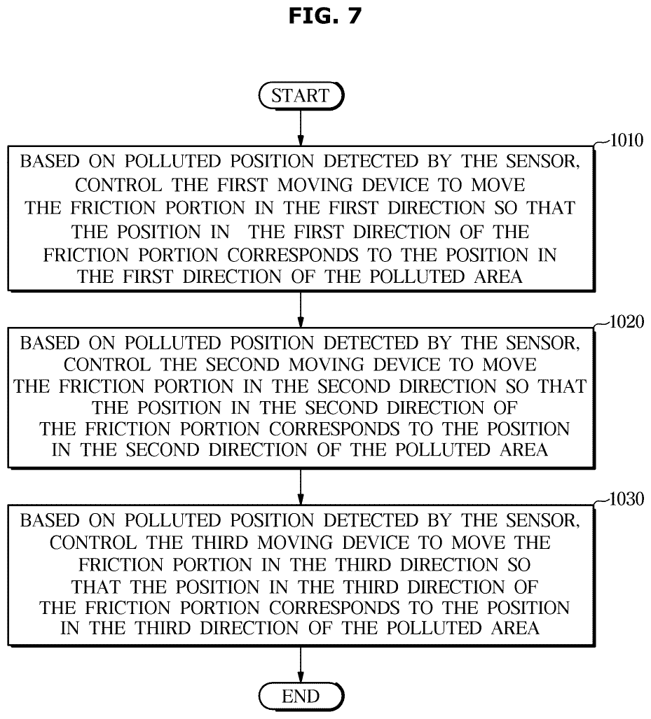

FIG. 5 is a control block diagram of a clothes care apparatus according to an embodiment of the disclosure. FIG. 6 is a view illustrating a friction portion of a cleaning device being moved to contact a polluted area of clothes in a clothes care apparatus according to an embodiment of the disclosure. FIG. 7 is a flowchart illustrating a method of controlling a clothes care apparatus, wherein a friction portion is moved to contact a polluted area, according to an embodiment of the disclosure.

Referring to FIGS. 5 to 7, the clothes care apparatus 1 may include a controller 300. The controller 300 may be electrically connected to memory 310 to control the operation of the clothes care apparatus 1 using data stored in the memory 310. The memory 310 and the controller 300 may each be implemented as separate chips. Alternatively, the memory 310 and the controller 300 may be implemented as a single chip.

The controller 300 may be electrically connected to the sensor 14, the auxiliary sensor 150, and the control panel CP to receive information. The controller 300 may be configured to receive information input by the user into the control panel CP. The controller 300 may be configured to receive information about the position of the polluted area P on the clothes C from the sensor 14. The controller 300 may be configured to receive information from the auxiliary sensor 150 about whether the cleaning of the polluted area P is complete.

The controller 300 may be electrically connected to the moving device 200, the spray portion 130, the suction portion 120, the display portion 60, and the ultrasonic generator 140. The controller 300 may control the moving device 200 to move the cleaning device 100 to the polluted area P based on information about the position of the polluted area P received from the sensor 14.

The controller 300 may control the spray portion 130 to allow the spray portion 130 to spray the plasma moisture air and detergent onto the position of the polluted area P. The controller 300 may control the suction portion 120 to draw in the polluted object PO generated during the cleaning process.

The controller 300 may control the display portion 60 to display the management status of clothes C to the user. The controller 300 may control the ultrasonic generator 140 to irradiate ultrasonic waves to the polluted area P. The specific method in which the controller 300 controls the moving device 200, the spray portion 130, the suction portion 120, the display portion 60, and the ultrasonic generator 140 will be described later.

Based on the clothes C being accommodated in the clothes management room 11, the clothes C may be placed between the support wall 136 and the cleaning device 100. In another expression, the support wall 136 may be arranged to support the clothes C on the opposite side of the friction portion 110 with respect to the clothes C based on the friction portion 110 pressing against the polluted area P.

The friction portion 110 included in the cleaning device 100 may be arranged to apply a physical force to the clothes C by contacting the clothes C. The friction portion 110 may include a friction body 112 protruding toward the second side 13b. The friction body 112 may include a friction block 1121 forming a shape. The friction body 112 may be coupled to one surface of the cleaning body 101 facing the support wall 136. The manner in which the friction body 112 is coupled to the cleaning body 101 may be arranged in a variety of ways.

The friction portion 110 may include a friction member 111 disposed on one surface of the friction body 112 facing the support wall 136. More particularly, the friction member 111 may be detachably coupled to one surface of the friction block 1121 disposed to face the support wall 136.

The friction member 111 may include friction member nodes 1111 forming a shape. The friction member 111 may include a friction surface 1112 formed on one surface of the friction member node 1111 facing the support wall 136. The friction surface 1112 may be arranged to be in direct contact with the clothes C to press and rub against the clothes C.

In an embodiment of the disclosure, the friction surface 1112 may include a plurality of friction protrusions 1113 protruding toward the support wall 136 to apply a frictional force to the clothes C. The plurality of friction protrusions 1113 may be arranged to be spaced apart from each other on the friction surface 1112. The plurality of friction protrusions 1113 described above may be an example of a technical configuration designed to effectively press and rub against the clothes C, and may include various shapes capable of applying a physical force to the clothes C.

In an embodiment of the disclosure, the friction surface 1112 and the plurality of friction protrusions 1113 may be formed integrally. In an embodiment of the disclosure, the plurality of friction protrusions 1113 may be formed by engraving the friction surface 1112. The friction surface 1112 and the plurality of friction protrusions 1113 may integrally form an uneven portion on one surface of the friction member 111.

Since the friction surface 1112 of the friction member 111 is in direct contact with the clothes C, it may be necessary to have a variety of shapes, materials, and friction coefficients depending on the material of the clothes C. In other words, the friction member 111 may need to be replaceable depending on the material of the clothes C. Replacement of the friction member 111 will be described in more detail later.

In the following, the process by which the controller 300 controls the moving device 200 to bring the friction portion 110 into contact with the polluted area P will be described.

In an embodiment of the disclosure, the controller 300 may receive the position information (x, y, z) of the polluted area P detected by the sensor 14. Based on the position information (x, y, z) of the polluted area P detected by the sensor 14, the controller 300 may control the first moving device 211 to move the friction portion 110 in the direction (+−Z direction) parallel to the first direction, so that the position (z) in the first direction of the friction portion 110 corresponds to the position (z) in the first direction of the polluted area P at operation 1010.

In other words, the first moving device 211, by the controller 300, may drive the first moving rail 212 to allow the friction surface 1112 of the friction portion 110 to be arranged at the position (z) corresponding to the position (z) in the first direction of the polluted area P.

The controller 300, based on the polluted position (x, y, z) detected by the sensor 14, may control the second moving device 221 to move the friction portion 110 in the direction parallel to the second direction (+−Y direction), so that the position (y) in the second direction of the friction portion 110 corresponds to the position (y) in the second direction of the polluted area P at operation 1020.

In other words, the second moving device 221, by the controller 300, may drive the second moving rail 222 to allow the friction surface 1112 of the friction portion 110 to be arranged at a position (y) corresponding to the position (y) in the second direction of polluted area P.

Thereafter, based on the polluted position (x, y, z) detected by the sensor 14, the controller 300 may control the third moving device 231 to move the friction portion 110 in the third direction (+−X direction), so that the position (x) in the third direction of the friction portion 110 corresponds to the position (x) in the third direction of the polluted area P at operation 1030.

The third moving device 231, by the controller 300, may cause the friction surface 1112 of the friction portion 110 to be arranged at the position (x) corresponding to the position (x) in the third direction of the polluted area P.

The driving of the first moving device 211, the second moving device 221, and the third moving device 231 may cause the friction surface 1112 of the friction portion 110 to be positioned at the polluted position (x, y, z). Accordingly, the friction surface 1112 may be brought into contact with the polluted area P.

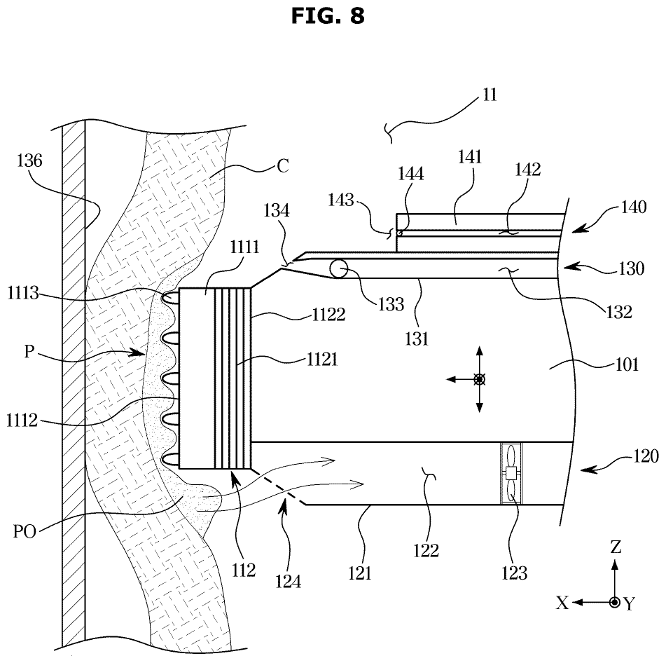

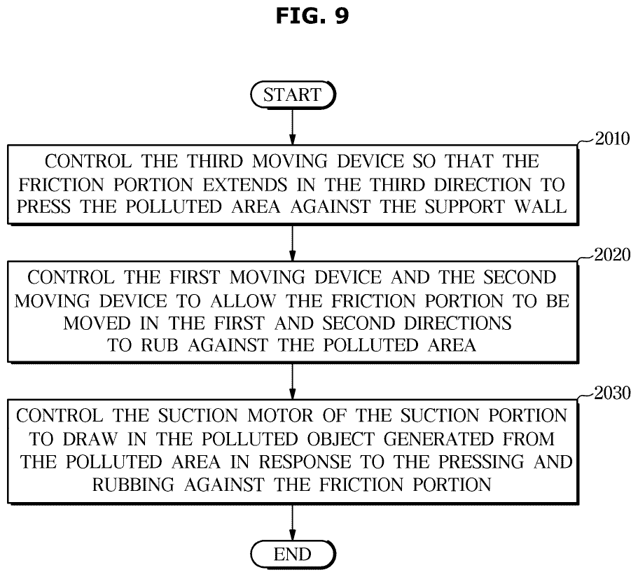

FIG. 8 is a view illustrating a clothes care apparatus, wherein a friction portion of a cleaning device is moved to press and rub against a polluted area, according to an embodiment of the disclosure. FIG. 9 is a flowchart illustrating a method of controlling a clothes care apparatus, wherein a friction portion presses and rubs against a polluted area and a suction draws in a polluted object, according to an embodiment of the disclosure.

Referring to FIGS. 8 and 9, the friction portion 110 in contact with the polluted area P of the clothes C may be moved by the moving device 200 to press and rub against the polluted area P.

More particularly, the controller 300 may control the third moving device 231 so that the friction portion 110 extends in the third direction to press the polluted area P against the support wall 136 at operation 2010.

Based on the third moving device 231 extending toward the support wall 136, the friction surface 1112 may press the polluted area P so that the clothes C comes into contact with the support wall 136. Then, the polluted area P may be supported by the support wall 136, and the friction surface 1112 may press the polluted area P more effectively.

In response to the friction surface 1112 pressing against the polluted area P, the controller 300 may control the first moving device 211 and the second moving device 221 to allow the friction portion 110 to be moved in the first and second directions at operation 2020. At this time, the third moving device 231 may not be driven, so that the polluted area P may remain pressed by the support wall 136. As a result, by driving the first moving device 211 and the second moving device 221, the friction surface 1112 may rub against the polluted area P to apply a mechanical force.

Since the frictional force is applied directly to the polluted area P by the friction surface 1112, the polluted area P may be cleaned more effectively. The friction process of the friction surface 1112 may cause the polluted object PO on the polluted area P to be removed from the clothes C, and to be separated from the clothes C and move downward (−Z side).

The polluted object PO removed from the clothes C may be drawn in by the suction portion 120. The controller 300 may control the operation of a suction motor 123 of the suction portion 120 to draw in the generated polluted object PO at operation 2030.

The suction portion 120 may include the suction motor 123 that generates a suction force and a suction flow path 122 through which the drawn-in polluted object PO moves. The suction motor 123 may be disposed in the suction flow path 122 to generate the suction force, but this is by way of example only and the suction motor 123 may be disposed in a variety of ways as long as it is capable of generating a suction force into a suction duct 121, which will be described later.

The suction portion 120 may include the suction duct 121 forming the suction flow path 122 and a suction hole 124 provided on one side of the suction duct 121 facing the support wall 136 to introduce the polluted object PO into the suction duct 121.

The suction duct 121 may be formed along a longitudinal direction of the cleaning body 101. The suction hole 124 may be arranged to communicate with the suction flow path 122. In the drawings, the suction hole 124 is shown as being formed as a plurality of suction holes 124, but the suction hole 124 may alternatively include a single suction hole 124.

The suction holes 124 may be disposed lower than the friction portion 110. As described above, the polluted object PO separated from the polluted area P by the pressure and friction of the friction portion 110 may move downwardly by gravity, so that the suction holes 124 (disposed lower than the friction portion 110) may effectively draw in the polluted object PO. Since the suction portion 120 is configured to remove the polluted object PO separated from the polluted area P, secondary contamination of the clothes C by the polluted object PO may be effectively prevented.

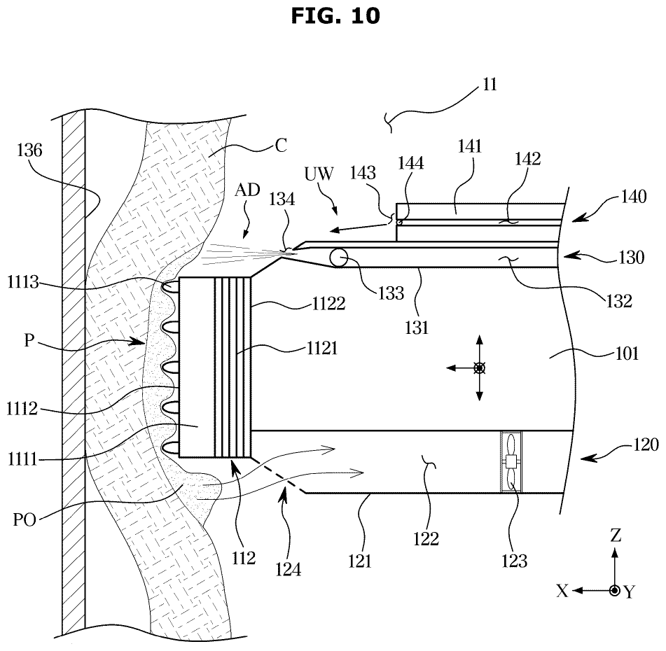

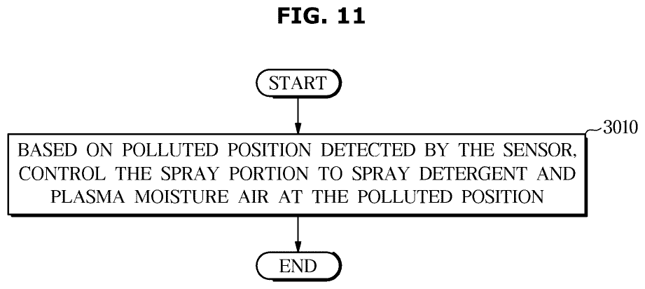

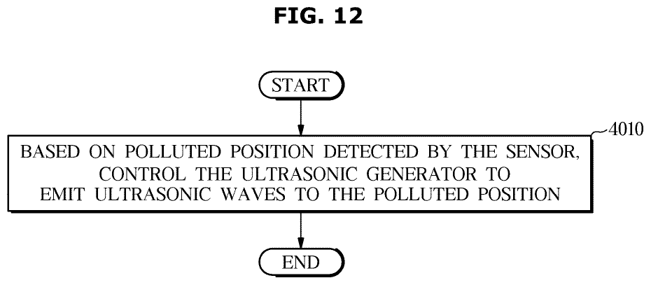

FIG. 10 is a view illustrating a clothes care apparatus, wherein a spray portion and an ultrasonic generator of a cleaning device are operated according to an embodiment of the disclosure. FIG. 11 is a flowchart illustrating a method of controlling clothes care apparatus to operate a spray portion according to an embodiment of the disclosure. FIG. 12 is a flowchart illustrating a method of controlling a clothes care apparatus to operate an ultrasonic generator according to an embodiment of the disclosure.

Referring to FIGS. 10 to 12, the cleaning device 100 may include the spray portion 130. The controller 300 may control the spray portion 130 to spray detergent and plasma moisture air at the polluted position (x, y, z) based on the polluted position (x, y, z) of the polluted area P detected by the sensor 14 at operation 3010.

In an embodiment of the disclosure, the spray portion 130 may be connected to the plasma generator 75 and the steam generator 70 to provide additional plasma moisture air to the clothes C. In an embodiment of the disclosure, the spray portion 130 may be arranged to spray detergent onto the polluted area P.

The spray portion 130 may include a spray duct 131 forming a spray flow path 132 through which the plasma moisture air and the detergent flow. The spray flow path 132 may be provided within the spray duct 131. In an embodiment of the disclosure, the spray duct 131 may be disposed within the cleaning body 101 in a direction in which the cleaning body 101 extends. In an embodiment of the disclosure, the spray duct 131 may be configured to penetrate the cleaning body 101.

The spray portion 130 may include a spray hole 134 that is open in a direction facing the support wall 136. The spray hole 134 may be configured to communicate with the spray flow path 132. The spray liquid may be directed to the polluted area P of the clothes C through the spray hole 134.

In an embodiment of the disclosure, the spray portion 130 may spray the spray liquid onto the polluted area P by electrostatically spraying the spray liquid. When a high voltage is applied to the spray liquid flowing in the spray flow path 132, oxidation radicals are formed, which may cause the charged liquid to be sprayed more uniformly due to electrical repulsion between liquid molecules. The sprayed liquid may be applied uniformly by transferring the charge to the clothes C, which has a relatively small amount of charge, and the cleaning effect may be further enhanced by oxidation radicals.

In an embodiment of the disclosure, a spray pump 133 may be disposed on the spray flow path 132. The spray pump 133 may be configured to provide a spray force for spraying the spray liquid flowing in the spray flow path 132 onto the clothes C. In an embodiment of the disclosure, the controller 300, which is electrically connected to the spray pump 133 of the spray portion 130, may control the spray pump 133 to perform additional spraying when additional spraying of the spray liquid is required.

In an embodiment of the disclosure, the spray portion 130 may be disposed on an upper side of the friction portion 110. When the spray liquid is sprayed from the spray portion 130, the spray liquid applied to the clothes C may flow downwardly due to gravity. Since the friction portion 110 is arranged lower than the spray portion 130, the friction portion 110 may receive the flowing spray liquid and clean the polluted area P more effectively. As a result, the cleaning effect of the polluted area P may be increased. In addition, since the suction portion 120 is disposed on a lower side of the friction portion 110, the spray liquid that is sprayed excessively may continue to flow downwardly and be removed by the suction portion 120.

The cleaning device 100 may include the ultrasonic generator 140 arranged to apply a physical force to the polluted area P. The controller 300 may control the ultrasonic generator 140 to irradiate ultrasonic waves to the polluted position (x, y, z) based on the polluted position (x, y, z) detected by the sensor 14 at operation 4010.

In an embodiment of the disclosure, the ultrasonic generator 140 may be disposed on an upper side of the suction portion 120 to direct ultrasonic waves to the polluted area P. As a result, the polluted object PO separated from the polluted area P by the ultrasonic generator 140 may flow downwardly and then be effectively removed by the suction portion 120. Thus, secondary contamination of the clothes C may be prevented.

In an embodiment of the disclosure, the cleaning device 100 may include an ultrasonic generator body portion 141 extending in a direction in which the cleaning body 101 extends, and a wire arrangement portion 142 formed within the ultrasonic generator body portion 141. The wire arrangement portion 142 may be formed within the ultrasonic generator body portion 141 along the direction in which the ultrasonic generator body portion 141 extends. The wires may be connected to an external power supply (not shown).

An ultrasonic transmitter 144 may be disposed on one side of the ultrasonic generator body portion 141 facing the support wall 136. In an embodiment of the disclosure, the ultrasonic transmitter 144 may be configured to irradiate ultrasonic waves to the polluted area P, including an ultrasonic lens or the like. The ultrasonic generator 140 may include an ultrasonic irradiation hole 143 in which the ultrasonic transmitter 144 may be disposed.

When ultrasonic waves are irradiated to the polluted area P through the ultrasonic generator 140, additional physical forces other than the frictional force provided by the friction portion 110 may act on the polluted area P. Thus, the effectiveness of the cleaning of the polluted area P may be further increased.

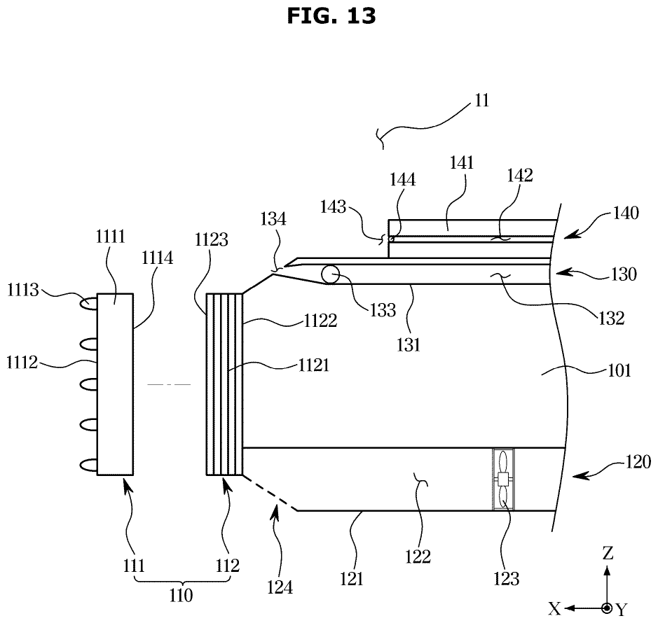

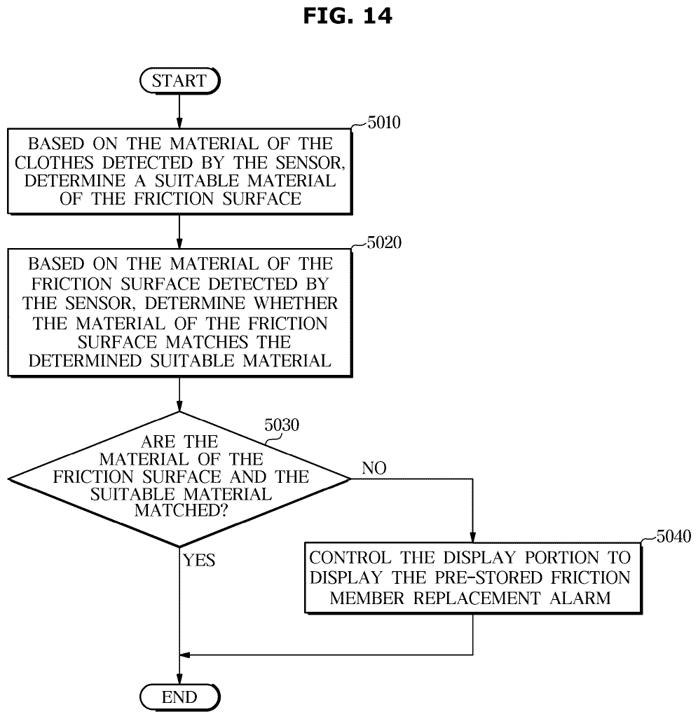

FIG. 13 is a view illustrating a friction body and a friction member of a spray portion being separated from each other in a clothes care apparatus according to an embodiment of the disclosure. FIG. 14 is a flowchart of a method of controlling a clothes care machine according to an embodiment of the disclosure.

Referring to FIGS. 13 and 14, the friction body 112 and the friction member 111 may be detachably coupled to each other. In an embodiment of the disclosure, the friction body 112 may include a friction body coupling surface 1123 formed on one surface of the friction block 1121 facing the support wall 136.

The friction member 111 may include a friction member coupling surface 1114 formed on one surface of the friction member node 1111 facing the friction body 112. The friction body coupling surface 1123 and the friction member coupling surface 1114 may contact each other and be detachably coupled. In other words, the friction member 111 may be configured to be replaceable.

Since the friction surface 1112 of the friction member 111 is configured to be in direct contact with the clothes C, the friction surface 1112 may need to be replaced depending on the material of the clothes C to minimize damage to the clothes C due to friction.

Accordingly, since the friction member 111 may be arranged to be detachable from the friction body 112 as described above, the user may replace the friction member 111 with the friction member 111 including the friction surface 1112 suitable for the material of the clothes C. Thus, damage to the clothes C may be minimized.

The material of the friction surface 1112 that rubs against the clothes C while minimizing damage to the clothes C may be defined as a ‘suitable material’.

In the following, the process by which the display portion 60 displays a friction member 111 replacement alarm so that the user attaches the friction member 111 having a suitable material to the friction portion 110 will be described.

In an embodiment of the disclosure, the sensor 14 may be configured to detect the material of the clothes C and the material of the friction surface 1112. Information about the material of the clothes C and the material of the friction surface 1112 detected by the sensor 14 may be transmitted to the controller 300.

The controller 300 may determine a pre-stored suitable material of the friction surface 1112 based on the material of the clothes C detected by the sensor 14 at operation 5010. The information about the pre-stored suitable material may be stored in the memory 310.

Then, based on the material of the friction surface 1112 detected by the sensor 14, the controller 300 may determine whether the material of the friction surface 1112 matches the determined suitable material at operation 5020.

In response to the material of the friction surface 1112 and the suitable material not matching, the controller 300 may control the display portion 60 to display a pre-stored friction member 111 replacement alarm at operations 5030 and 5040.

The user may replace the friction member 111 to allow the friction member 111 to include the friction surface 1112 with a suitable material through the friction member 111 replacement alarm displayed on the display portion 60. Thus, it is possible to manage the clothes C by minimizing damage to the clothes C.

In an embodiment of the disclosure, the sensor 14 may be configured to detect a degree of wear of the friction surface 1112. Information about the degree of wear of the friction surface 1112 detected by the sensor 14 may be transmitted to the controller 300.

Based on the degree of wear of the friction surface 1112 detected by the sensor 14, the controller 300 may compare the degree of wear of the friction surface 1112 to a pre-stored wear limit. Upon determining that the degree of wear of the friction surface 1112 is greater than the pre-stored wear limit, the controller 300 may control the display portion 60 to allow the display portion 60 to display the friction member 111 replacement alarm.

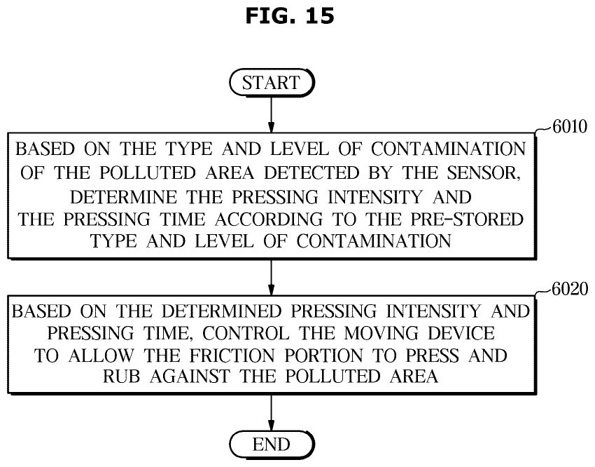

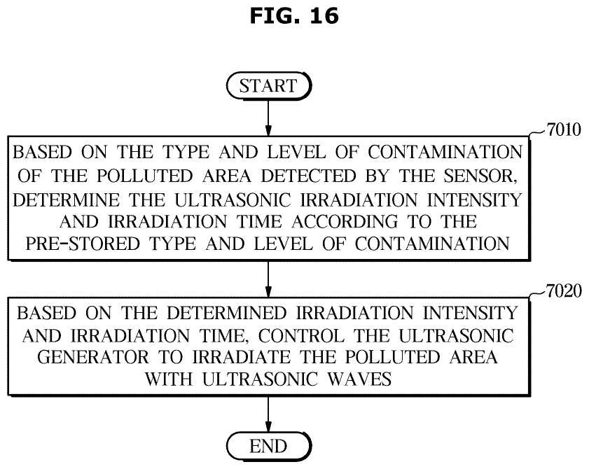

FIG. 15 is a flowchart illustrating a method of controlling a clothes care apparatus according to an embodiment of the disclosure. FIG. 16 is a flowchart illustrating a method of controlling a clothes care apparatus according to an embodiment of the disclosure.

Referring to FIGS. 15 and 16, the sensor 14 may be configured to detect a type of contamination and a level of contamination in the polluted area P.

Information regarding the type of and level of contaminations detected by the sensor 14 may be transmitted to the controller 300. Based on the received information regarding the type and level of contamination of the polluted area P, the controller 300 may determine a pressing intensity and a pressing time according to a pre-stored type and level of contamination at operation 6010.

In an embodiment of the disclosure, the pressing intensity and pressing time described above may be the intensity and time at which the friction portion 110 presses and rubs against the polluted area P of the clothes C.

Based on the determined pressing intensity and pressing time, the controller 300 may control the moving device 200 to allow the friction portion 110 to press and rub against the polluted area P at operation 6020.

More particularly, the controller 300 may control the moving device 200 to allow the friction portion 110 to press and rub against the polluted area P at a determined pressure intensity. In addition, the controller 300 may control the moving device 200 to allow the friction portion 110 to press and rub against the polluted area P for a determined pressing time.

Since the physical force is applied to the polluted area P according to the pre-stored pressure intensity and pressing time based on the type and level of contamination of the polluted area P, it is possible to prevent excessive physical force from being applied to the clothes C. Thus, it is possible to manage the clothes C while minimizing damage to the clothes C.

Information regarding the type and level of contamination detected by the sensor 14 may be transmitted to the controller 300. Based on the received information regarding the type and level of contamination the polluted area P, the controller 300 may determine an ultrasonic irradiation intensity and irradiation time according to the pre-stored type and level of contamination at operation 7010.

In an embodiment of the disclosure, the irradiation intensity and irradiation time described above may be the intensity and time at which the ultrasonic generator 140 irradiates ultrasonic waves to the polluted area P of the clothes C.

The controller 300 may control the ultrasonic generator 140 to irradiate the polluted area P with ultrasonic waves based on the determined irradiation intensity and irradiation time at operation 7020.

More particularly, the controller 300 may control the ultrasonic generator 140 to irradiate the polluted area P with ultrasonic waves at a determined irradiation intensity. In addition, the controller 300 may control the ultrasonic generator 140 to irradiate the polluted area P with ultrasonic waves for a determined irradiation time.

Since the physical force caused by the ultrasonic waves is applied to the polluted area P by the pre-stored irradiation intensity and irradiation time based on the type and level of contamination of the polluted area P, it is possible to prevent the phenomenon of excessive physical force from acting on the clothes C. Thus, it is possible to manage the clothes C while minimizing damage to the clothes C.

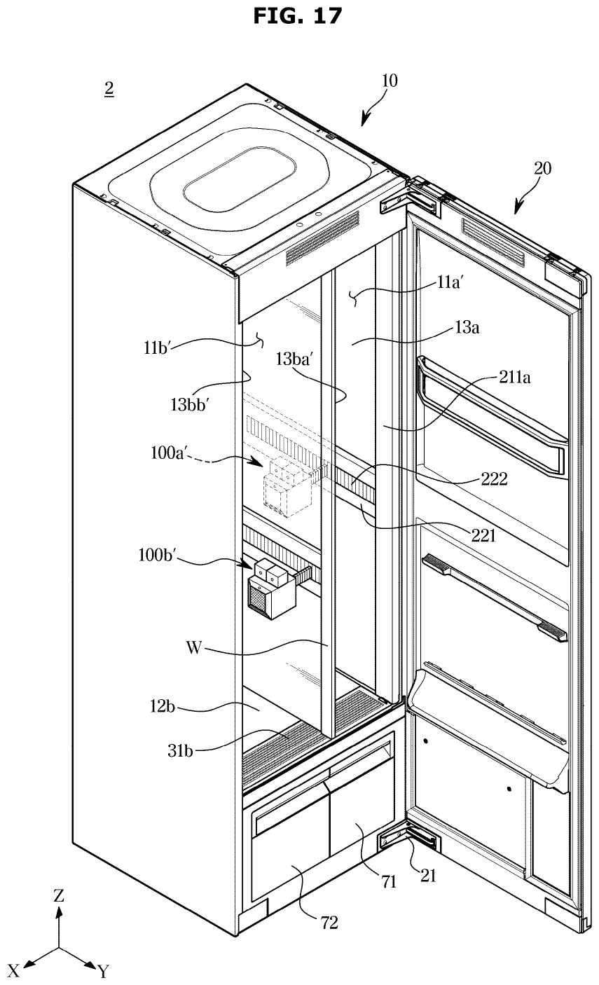

FIG. 17 is a view illustrating a state in which a door of a clothes care apparatus is open according to an embodiment of the disclosure.

Duplication of description with the above description will be omitted below.

Referring to FIG. 17, the main body 10 of the clothes care apparatus 2 may include a partition wall W dividing the clothes management room 11 into a first clothes management room 11a′ and a second clothes management room 11b′. In an embodiment of the disclosure, the partition wall W may be arranged to extend in the front-to-back direction (+−Y direction) to divide the clothes management room 11.

Although the partition wall W is shown in the drawing as being positioned to divide the first and second garment management rooms 11a′ and 11b′ such that their volumes are the same, but the position of the partition wall W is limited thereto. Since the volume of clothes C accommodated in the clothes management room 11 varies, the partition wall W may be arranged in different positions to divide the first clothes management room 11a′ and the second clothes management room 11b′.

In an embodiment of the disclosure, an upper end side of the partition wall W may be supported on the upper surface of the clothes management room 11, and a lower end side may be supported on the lower surface thereof. A rear end side of the partition wall W may be supported on the rear surface 12e.

The hanger 16 may be placed in the first clothes management room 11a′ and the second clothes management room 11b′, respectively. Accordingly, the user may place the clothes C in the first clothes management room 11a′ and the second clothes management room 11b′, respectively.

A first cleaning device 100a′ may be arranged in in the first clothes management room 11a′. A second cleaning device 100b′ may be arranged in the second clothes management room 11b′. In addition, the first clothes management room 11a′ and the second clothes management room 11b′ may each be provided with a moving device capable of independently moving the first cleaning device 100a′ and the second cleaning device 100b′.

The first cleaning device 100a′ may be provided to apply a physical force to the clothes C accommodated in the first clothes care room 11a′. In this case, the polluted area P of the clothes C accommodated in the first clothes management room 11a′ may be supported on one surface 13ba′ of the partition wall W facing the first clothes management room 11a′. The one surface 13ba′ of the partition wall W facing the first clothes management room 11a′ may be defined as the first support wall 13ba′. The polluted area P of the clothes C accommodated in the first clothes management room 11a′ may be removed by the first cleaning device 100a′ by pressing and rubbing against the first support wall 13ba′.

The second cleaning device 100b′ may be provided to apply a physical force to the clothes C accommodated in the second clothes management room 11b′. In this case, the moving device 200 accommodated in the second clothes management room 11b′ may be supported on one surface of the partition wall W facing the second clothes management room 11b′.

The polluted area P of the clothes C accommodated in the second clothes management room 11b′ may be supported by, and pressed and rubbed against, a second support wall 13bb′ of the main body 10. In an embodiment of the disclosure, the second support wall 13bb′ may be an inner surface of the main body 10 facing the second clothes management room 11b′. The second support wall 13bb′ may be a portion of the main body 10 facing in a direction (−X direction) corresponding to the direction in which the support wall 13b of the partition wall W faces.

The polluted area P of the clothes C accommodated in the second clothes management room 11b′ may be removed by the second cleaning device 100b′ by pressing and rubbing against the second support wall 13bb′.

The clothes care apparatus 1 according to an embodiment may include the main body 10 forming the clothes management room 11 for accommodating the clothes C therein and configured to spray plasma moisture air and detergent into the clothes management room 11. The clothes care apparatus 1 may include the sensor 14 configured to detect the position of the polluted area P of the clothes C. The clothes care apparatus 1 may include the cleaning device 100 including the friction portion 110 configured to apply a physical force to the polluted area P. The clothes care apparatus 1 may include the moving device 200 configured to move the friction portion 110 to the position of the polluted area P to allow the friction portion 110 to contact the polluted area P to press and rub against the polluted area P.

The cleaning device 100 may further include the suction portion 120 configured to draw in the polluted object PO generated from the polluted area P.

The suction portion 120 may include the suction motor 123 that generates a suction force. The suction portion 120 may include the suction duct 121 including the suction hole 124 through which polluted object PO moves in by the suction force. The suction portion 120 may include the suction flow path 122 formed within the suction duct 121, communicates with the suction hole 124, and through which the suctioned polluted object (PO) moves.

The suction hole 124 may be disposed on a lower side of the friction portion 110 to draw in the polluted object PO generated from the polluted area P in response to the friction portion 110 pressing and rubbing against the polluted area P.

The main body 10 may include the support wall 13b configured to support the clothes C on the opposite side of the friction portion 110 with respect to the clothes C in response to the friction portion 110 pressing against the polluted area P.

The friction portion 110 may include the friction body 112 protruding toward the support wall 13b and the friction surface 1112 disposed toward the support wall 13b to be in direct contact with the polluted area P. The friction portion 110 may include the friction member 111 disposed on one surface of the friction body 112 facing the support wall 13b. The friction member 111 may be detachably coupled to the friction body 112.

The friction member 111 may further include the coupling surface formed to be couplable to one surface of the friction body 112. The friction surface 1112 may include the plurality of friction protrusions 1113 formed toward the support wall 13b so as to rub the polluted area P.

The moving device 200 may include the first moving device 211 arranged to extend in the first direction (+−Z direction) within the clothes management room 11. The moving device 200 may include the second moving device 221 that extends in the second direction (+−Y direction) intersecting the first direction within the clothes management room 11, and is connected to the first moving device 211 so as to be movable in the direction parallel to the first direction along the first moving device 211. The first moving device 211 and the second moving device 221 may be disposed on the inner surface of the main body 10 facing the support wall 13b.

The moving device 200 may further include the third moving device 231 connected to the second moving device 221 so as to be movable in the direction parallel to the second direction along the second moving device 221, and configured to extend from the inner surface of the main body 10 in the third direction (+−X direction) facing the support wall 13b. The cleaning device 100 may be disposed at an end of the third moving device 231 facing the support wall 13b.

The cleaning device 100 may further include the spray portion 130 configured to spray the plasma moisture air and the detergent at the position of the polluted area P. The spray portion 130 may be disposed on the upper side of the friction portion 110 and the suction portion 120.

The clothes care apparatus 1 may further include the display portion 60 provided on the main body 10. The clothes care apparatus 1 may further include the controller 300 electrically connected to the sensor 14, the moving device 200, the suction portion 120, the spray portion 130, and the display portion 60.

The friction portion 110 may include the friction surface 1112 in contact with the polluted area P. The sensor 14 may be configured to detect the material of the clothes C placed in the clothes management room 11 and the material of the friction surface 1112. The controller 300 may determine the suitable material of the friction surface 1112 based on the material of the clothes C detected by the sensor 14 at operation 5010. Based on the suitable material, the controller 300 may determine whether the detected material of the friction surface 1112 matches the suitable material at operation 5020. The controller 300 may control the display portion 60 to display the pre-stored friction member 111 replacement alarm based on whether the detected material of the friction surface 1112 matches the suitable material at operations 5030 and 5040.

The sensor 14 may be configured to detect the type and level of contamination of the polluted area P. Based on the type and level of contamination detected by the sensor 14 at operation 6010, the controller 300 may the moving device 200 to adjust the time and intensity with which the friction portion 110 presses and rubs against the polluted area P at operation 6020.

The cleaning device 100 may further include the ultrasonic generator 140 configured to emit ultrasonic waves to the polluted area P and electrically connected to the controller 300. Based on the type and level of contamination detected by the sensor 14 at operation 7010, the controller 300 may control the ultrasonic generator 140 to adjust the intensity and time of the ultrasonic waves emitted to the polluted area P at operation 7020.

The cleaning device 100 may further include the auxiliary sensor 150 that detects the polluted area P to determine whether the cleaning of the polluted area P is completed.

The clothes care apparatus 1 according to an embodiment may include the main body 10 forming the clothes management room 11 that accommodates the clothes C therein, wherein an inner surface of the main body 10 forms the support wall 13b supporting the clothes C and the main body 10 is configured to spray plasma moisture air and detergent into the clothes management room 11. The clothes care apparatus 1 may include the sensor 14 configured to detect the position of the polluted area P of the clothes C. The clothes care apparatus 1 may include the cleaning device 100 configured to press and rub against the polluted area P. The clothes care apparatus 1 may include the moving device 200 configured to move the cleaning device 100 to allow the cleaning device 100 to contact the polluted area P. The moving device 200 may include the first moving device 211 arranged to extend in the first direction within the clothes management room 11. The moving device 200 may include the second moving device 221 extending in the second direction intersecting the first direction and connected to the first moving device 211 to be movable in the direction parallel to the first direction. The moving device 200 may include the third moving device 231 connected to the second moving device 221 so as to be movable in the direction parallel to the second direction, and configured to extend from the other surface of the main body 10 facing the inner surface in the third direction facing the support wall 13b. The cleaning device 100 may be disposed at an end of the third moving device 231 facing the support wall 13b.

The first moving device 211, the second moving device 221, and the third moving device 231 may move the cleaning device 100 to cause the cleaning device 100 to contact the polluted area P. The third moving device 231 may move the cleaning device 100 toward the support wall 13b to allow the cleaning device 100 to press the polluted area P against the support wall 13b. The first moving device 211 and the second moving device 221 may move the cleaning device 100 to allow the cleaning device 100 to rub the polluted area P pressed against the support wall 13b.

The cleaning device 100 may further include the suction portion 120 configured to draw in polluted object PO generated from the polluted area P.

The clothes care apparatus 1 according to an embodiment may include the main body 10 forming the clothes management room 11 accommodating the clothes C therein, and configured to spray plasma moisture air and detergent into the clothes management room 11. The clothes care apparatus 1 may include the sensor 14 configured to detect the position of the polluted area P of the clothes C. The clothes care apparatus 1 may include the cleaning device 100 configured to apply a physical force to the polluted area P. The clothes care apparatus 1 may include the moving device 200 connected to the cleaning device 100 and configured to move the cleaning device 100. The movement of the cleaning device 100 by the moving device 200 may include moving to the position of the polluted area P so as to contact the polluted area P. The movement of the cleaning device 100 may include moving to the support wall 13b, which is the inner surface of the main body 10 formed on the opposite side of the cleaning device 100 with respect to the clothes C, so as to press the polluted area P against the support wall 13b, and moving in the direction in which the support wall 13b extends to rub against the pressed polluted area P.

The cleaning device 100 may further include the suction portion 120 configured to draw in polluted object PO generated from the polluted area P.

According to the spirit of the disclosure, a mechanical force may be applied to the polluted area of the clothes by the friction portion, thereby increasing the effectiveness of cleaning the polluted area, resulting in improved clothes care.

According to the spirit of the disclosure, secondary contamination of the clothes due to the polluted object may be prevented by allowing the suction portion to absorb the polluted object generated from the polluted area.

According to the spirit of the disclosure, the user may replace the friction member so that the friction surface has a suitable material through the friction member replacement alarm on the display portion, thereby minimizing damage to the clothes and managing the clothes.

According to the spirit of the disclosure, the intensity and time of the physical force acting on the polluted area may be adjusted based on the type and level of contamination of the polluted area, thereby minimizing damage to the clothes and managing the clothing.

The effects to be obtained from the disclosure are not limited to the effects those mentioned above, and other effects not mentioned will be apparent to be those of skilled in the art to which the disclosure belongs from the following description.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those of skilled in the art that various changes in form and details may be made therein without departing from the spirit and scope of the disclosure as defined by the appended claims and their equivalents.

What is claimed is:

1. A clothes care apparatus comprising:
a main body forming a clothes management room for accommodating a clothes therein and configured to spray plasma moisture air and detergent into the clothes management room;
a sensor configured to detect a position of a polluted area of the clothes;
a cleaning device including a friction portion configured to apply a physical force to the polluted area; and
a moving device configured to move the friction portion to the position of the polluted area to allow the friction portion to contact the polluted area to press and rub against the polluted area.

2. The clothes care apparatus of claim 1, wherein the cleaning device further includes a suction portion configured to draw in a polluted object generated from the polluted area.

3. The clothes care apparatus of claim 2, wherein the suction portion comprises:
a suction motor configured to generate a suction force,
a suction duct including a suction hole through which the polluted object is drawn in by the suction force, and
a suction flow path formed within the suction duct, communicating with the suction hole, and through which the drawn-in polluted object moves.

4. The clothes care apparatus of claim 3, wherein the suction hole is disposed on a lower side of the friction portion to draw in the polluted object generated from the polluted area in response to the friction portion pressing and rubbing against the polluted area.

5. The clothes care apparatus of claim 1, wherein the main body includes a support wall configured to support the clothes on the opposite side of the friction portion with respect to the clothes in response to the friction portion pressing against the polluted area.

6. The clothes care apparatus of claim 5,
wherein the friction portion comprises:
a friction body protruding toward the support wall, and
a friction member including a friction surface disposed toward the support wall to be in direct contact with the polluted area, the friction member disposed on one surface of the friction body facing the support wall, and
wherein the friction member is detachably coupled to the friction body.

7. The clothes care apparatus of claim 6,
wherein the friction member further includes a coupling surface formed to be couplable to one surface of the friction body, and
wherein the friction surface includes a plurality of friction protrusions formed toward the support wall so as to rub the polluted area.

8. The clothes care apparatus of claim 5,
wherein the moving device comprises:
a first moving device arranged to extend in a first direction within the clothes management room, and
a second moving device extending in a second direction intersecting the first direction within the clothes management room, and connected to the first moving device so as to be movable in a direction parallel to the first direction along the first moving device, and
wherein the first moving device and the second moving device are disposed on an inner surface of the main body facing the support wall.

9. The clothes care apparatus of claim 8,
wherein the moving device further includes a third moving device connected to the second moving device so as to be movable in a direction parallel to the second direction along the second moving device, and extendable from the inner surface of the main body in a third direction facing the support wall, and
wherein the cleaning device is disposed at an end of the third moving device facing the support wall.

10. The clothes care apparatus of claim 2,
wherein the cleaning device further includes a spray portion configured to spray plasma moisture air and detergent onto the position of the polluted area, and
wherein the spray portion is disposed on an upper side of the friction portion and the suction portion.

11. The clothes care apparatus of claim 10, further comprising:
a display portion on the main body; and
a controller electrically connected to the sensor, the moving device, the suction portion, the spray portion, and the display portion.

12. The clothes care apparatus of claim 11,
wherein the friction portion includes a friction surface in contact with the polluted area,
wherein the sensor is configured to detect a material of the clothes placed in the clothes management room and a material of the friction surface, and
wherein the controller is configured to:
determine, based on the material of the clothes detected by the sensor, a suitable material of the friction surface,
determine, based on the suitable material, whether the material of the friction surface matches the suitable material, and
control, based on whether the detected material of the friction surface matches the suitable material, the display portion to display a pre-stored friction member replacement alarm.

13. The clothes care apparatus of claim 11,
wherein the sensor is configured to detect a type and level of contamination of the polluted area, and
wherein the controller is configured to control, based on the type and level of contamination detected by the sensor, the moving device to adjust the time and intensity with which the friction portion presses and rubs against the polluted area.

14. The clothes care apparatus of claim 13,
wherein the cleaning device further includes an ultrasonic generator configured to emit ultrasonic waves to the polluted area and electrically connected to the controller, and
wherein the controller is configured to control, based on the type and level of contamination detected by the sensor, the ultrasonic generator to adjust the intensity and time of the ultrasonic waves emitted to the polluted area.

15. The clothes care apparatus of claim 1, wherein the cleaning device further includes an auxiliary sensor for detecting the polluted area to determine whether the cleaning of the polluted area is completed.

16. The clothes care apparatus of claim 12, further comprising:
based on a degree of wear of the friction surface detected by the sensor, the controller may compare the degree of wear of the friction surface to a pre-stored wear limit.

17. The clothes care apparatus of claim 16, further comprising:
upon determining that the degree of wear of the friction surface is greater than the pre-stored wear limit, the controller is further is configured to control the display portion to allow the display portion to display the pre-stored friction member replacement alarm.

18. A clothes care apparatus comprising:
a main body forming a clothes management room that accommodates a clothes therein, wherein an inner surface of the main body forms a support wall supporting the clothes and the main body is configured to spray plasma moisture air and detergent into the clothes management room;
a sensor configured to detect a position of a polluted area of the clothes;
a cleaning device configured to press and rub against the polluted area; and
a moving device configured to move the cleaning device to allow the cleaning device to contact the polluted area,
wherein the moving device includes a first moving device arranged to extend in a first direction within the clothes management room,
wherein the moving device includes a second moving device extending in a second direction intersecting the first direction and connected to the first moving device to be movable in a direction parallel to the first direction,
wherein the moving device includes a third moving device connected to the second moving device so as to be movable in the direction parallel to the second direction, and configured to extend from another surface of the main body facing the inner surface in the third direction facing the support wall, and
wherein the cleaning device is disposed at an end of the third moving device facing the support wall.

19. A clothes care apparatus comprising:
a main body forming a clothes management room accommodating a clothes therein, and configured to spray plasma moisture air and detergent into the clothes management room;
a sensor configured to detect a position of a polluted area of the clothes;
a cleaning device configured to apply a physical force to the polluted area; and
a moving device connected to the cleaning device and configured to move the cleaning device,
wherein the movement of the cleaning device by the moving device includes moving to the position of the polluted area so as to contact the polluted area, and
wherein the movement of the cleaning device includes moving to a support wall, which is an inner surface of the main body formed on the opposite side of the cleaning device with respect to the clothes, so as to press the polluted area against the support wall, and moving in the direction in which the support wall extends to rub against the pressed polluted area.
